(19) United States
(12) Patent Application Publication
(10) Pub. No.: US 2005/0156811 A1
(43) Pub. Date: Jul. 21, 2005

(54) Display system and electronic equipment using the same

(75) Inventors: Naoyasu Ikeda, Tokyo (JP); Hideki Asada, Tokyo (JP); Setsuo Kaneko, Tokyo (JP)

Correspondence Address: FOLEY AND LARDNER;SUITE 500, 3000 K STREET NW, WASHINGTON, DC, 20007, US

(73) Assignee: NEC CORPORATION

(21) Appl. No.: 10/985,894

(22) Filed: Nov. 12, 2004

(30) Foreign Application Priority Data
Nov. 25, 2003 (JP) 2003-393289

(51) Int. Cl. G09G 5/00

(52) U.S. Cl. 345/1.1

(57) ABSTRACT

In a display system in which display units with two screens are combined, suppressing an enlargement of the display system and suppressing a cost increase. There are provided one display unit formed on one insulating substrate, another display unit formed on another insulating substrate, and a circuit module for outputting display driving signals. The size of the other display unit is set to be smaller than that of the one display unit. The circuit module is formed on the one insulating substrate, and outputs the display driving signals to the one display device and to the other display device, respectively.

### BACKGROUND OF THE INVENTION

1. Field of the Invention

The present invention relates to display systems in which a plurality of display units are connected and to electronic equipment using the same, and also relates to display systems of portable telephones and the like with a plurality of display units and to electronic equipment using the same.

2. Related Art

As electronic equipment placing importance on portability such as portable telephones have been developed, display systems are also developed to be colorized and to have higher definition. In particular, there is known electronic equipment using a display system in which a number of screens are arranged on a number of faces of the casing or on upper and lower parts of the same face (for example, see Japanese Patent Application Laid-open No. 2002-278518A, and Japanese Patent Application Laid-open No. 2002-304136A). FIG. 1 shows an example of a portable telephone in which two screens are mounted. As shown in FIG. 1, a portable telephone 1 is provided with an STN liquid crystal panel 41 and a TFT liquid crystal panel 42. FIG. 2 is a block diagram showing the main part of the display system of the portable telephone 1. As shown in FIG. 2, the display system of the conventional example includes a key manipulation unit 43, a control unit 44, an STN liquid crystal controller 45, an STN liquid crystal panel 41, a TFT liquid crystal controller 46, a TFT liquid crystal panel 42, and a backlight circuit 47.

FIG. 3 is a schematic diagram showing a portable telephone provided with a display system having an organic EL (electro-luminescence) display device and a liquid crystal display device. As shown in FIG. 3, the portable telephone 1 is provided with an organic EL panel 48 and a liquid crystal panel 49. FIG. 4 is a block diagram showing the display system of the portable telephone shown in FIG. 3. As shown in FIG. 4, the display system includes a power supply circuit 50, a clock generating circuit 51, a circuit of outputting display information for liquid crystal 52, a circuit of outputting display information for organic EL 53, a circuit of processing display information for liquid crystal 54, a circuit of processing display information for organic EL 55, a liquid crystal panel 49 with a data line driving circuit 56 and a scan line driving circuit 57, and an organic EL panel 48 with a data line driving circuit 58 and a scan line driving circuit 59.

An object of the conventional art is to perform an efficient use of electronic equipment by, for example, using either one of the displays so as to suppress the power consumption of the electronic equipment. For example, in a portable telephone where two screens are provided to the display system, when it is in the standby mode, only a few pieces of information such as the residue of the battery and current time should be displayed. Thereby these pieces of information are displayed on one screen, and the other screen is off. In this way, it is possible to reduce the power consumption.

In the aforementioned conventional art, all driving circuits for driving the display panels are mounted on a wiring board, and the wiring board and the display panels are connected via a flat cable, or circuits for driving respective panels are arranged to respective display panels.

However, in the former case, the wiring board and the flat cable become larger, whereby the display system becomes larger. Further, in the latter case, two sets of circuits performing the same operation should be prepared, which also causes to enlarge the display system. Further, since it is required to form circuits performing the same operation in the two panels, both of TFTs for high breakdown voltage and TFTs for low breakdown voltage must be formed in the both panels, which causes complex processes and lowering of the yield.

In order to solve these problems, a method of sharing circuits is proposed (for example, see Gekkan Display, February 2003, pp. 19-24, hereinafter referred to as Non-patent Document 1). FIG. 5 shows an example of a solution described in Non-paten Document 1. FIG. 5 illustrates a case where a main display and a back face display are mounted in a portable telephone. In FIG. 5, the portable telephone includes a main display 60, a back face display 61, a display device 62 of the main display, a display device 63 of the back face display, a data driver IC 64, a gate driver IC 65, a wiring 66 between the gate driver IC and gate bus lines of the main display 60, wiring 67 to the gate bus lines of the back face display 61, a printed board 68, and flat cables 69 connecting the main display and the back face display and connecting the main display and the printed board.

In this conventional example, a gate driver circuit for two displays are incorporated in one gate driver IC 65. Further, the data driver circuit shares the data drive IC 94 for the main display and the back face display. Wiring from the gate driver IC 65 to the back face display uses a part of the wiring 66 arranged beside the main display. Further, wiring from the data driver IC 64 to the back face display uses the data bus lines of the main display 60 as they are, which are connected from the data driver IC 64 to the data bus lines of the back face display via the data bus lines of the main display 60.

With this system, two IC chips can constitute two-screen display, whereby it is possible to reduce the trim area of the display and also to reduce the cost, comparing with the case of using a conventional method.

However, in the method described in Non-patent Document 1, although the trim area is reduced comparing with the case of using the method described in Japanese Patent Application Laid-open No. 2002-304136A in which driving circuits are mounted to the display panels, the width of the trim in a lateral direction of the main display 60 becomes larger by the wiring to the gate bus lines of the back face display. This causes a problem of an increase in volume when, for example, the method is applied to equipment where the lateral width is limited such as a case of a portable telephone.

### SUMMARY OF THE INVENTION

The present invention is developed to solve the aforementioned problems that the conventional art has. An object of the present invention is to simplify the circuit structure of a display system as a whole, and to enable a trim area to be suppressed even in a display system with high resolution.

In order to achieve the aforementioned object, the present invention comprises: one display unit formed on one substrate; another display unit formed on another substrate; and a circuit module for outputting display driving signals. The size of the other display unit is set to be smaller than the size of the one display unit, and the circuit module is formed on the other insulating substrate, and outputs the display driving signals to the one display unit and to the other display unit, respectively.

With the configuration described above, circuits can be mounted in concentration on the small display unit side, whereby it is possible to provide a further miniaturized display system, when the display system is viewed as a whole.

Further, it is possible that the display units are configured to include thin film field effect transistors and display devices driven by the thin film field effect transistors on the insulating substrates, and that the circuit module is configured to output display driving signals for driving the display devices by driving the thin film field effect transistors.

As described above, since one display unit is formed on one insulating substrate and another display unit and a circuit module are formed on another insulating film, it is possible to select manufacturing processes appropriately by an insulating substrate unit, in such a manner that a high breakdown voltage TFT process and a low breakdown voltage TFT process, or a CMOS process and a p-channel or n-channel process only, to thereby improve the yield of the manufacturing. At the same time, since the manufacturing process is simplified, it is possible to reduce the cost of the display system as a whole. Further, the trim area can be reduced due to the shared circuits.

Further, in a case of adopting an outside integrated circuit chip as a part of a circuit module, the outside integrated circuit chip may be so formed that only a portion performing operation at low voltage like 3.3V is integrated, and interfaces with high voltage circuits for driving display units are mounted on the insulating substrates. Thereby, it is possible to simplify the manufacturing process of the integrated circuit chip and to reduce the area, which enables to reduce the cost of the outside integrated circuit chip.

### BRIEF DESCRIPTION OF THE DRAWINGS

FIG. 1 is a schematic diagram showing a first conventional example of a portable telephone;

FIG. 2 is a block diagram showing a first conventional example of a display system;

FIG. 3 is a schematic diagram showing a second conventional example of a portable telephone;

FIG. 4 is a block diagram showing a second conventional example of a display system;

FIG. 5 is a block diagram showing a third conventional example of a display system;

FIG. 6 is a schematic diagram of a main body showing an example of electronic equipment according to the present invention;

FIG. 7 is a block diagram showing a display system according to a first embodiment of the present invention;

FIG. 8 is a block diagram showing a DAC circuit in a circuit module 13 according to the first embodiment of the present invention;

FIG. 9 is a chart showing selection timings of a gate driver of the display system according to the first embodiment of the present invention;

FIG. 10 is a timing chart showing the operation of the DAC circuit in a period T3 according to the first embodiment of the present invention;

FIG. 11 is a chart showing the circuit structure of a switching circuit 11 according to the first embodiment of the present invention;

FIG. 12 is a timing chart of switching signals SD1 to SD9 according to the first embodiment of the present invention;

FIG. 13 is a timing chart showing the operation of the DAC circuit in a period T4 according to the first embodiment of the present invention;

FIG. 14 is a chart showing the circuit structure of a switching circuit 14 according to the first embodiment of the present invention;

FIG. 15 is a timing chart of switching signals SDA1 to SDA6 according to the first embodiment of the present invention;

FIG. 16 is a diagram showing an example of substitute arrangement of the first embodiment of the present invention;

FIG. 17 is a block diagram showing a display system according to a second embodiment of the present invention;

FIG. 18 is a block diagram showing the configuration of a DAC circuit and a memory circuit according to the second embodiment of the present invention;

FIG. 19 is a block diagram showing a display system according to a third embodiment of the present invention;

FIG. 20 is a block diagram showing the configuration of a DAC circuit and a memory circuit according to the third embodiment of the present invention;

FIG. 21 is a block diagram showing a display system of a forth embodiment of the present invention;

FIG. 22 is a block diagram showing a DAC circuit in a circuit module 13 according to the forth embodiment of the present invention;

FIG. 23 is a diagram showing the configuration of pixels according to the forth embodiment of the present invention;

FIG. 24 is a chart showing selection timings of a gate driver of the display system according to the forth embodiment of the present invention;

FIG. 25 is a timing chart showing the operation of the DAC circuit in a period T3 according to the forth embodiment of the present invention;

FIG. 26 is a chart showing the circuit structure of the switching circuit 11 according to the forth embodiment of the present invention;

FIG. 27 is a timing chart of switching signals SD1 to SD9 according to the forth embodiment of the present invention;

FIG. 28 is a timing chart showing the operation of the DAC circuit in a period T4 according to the forth embodiment of the present invention;

FIG. 29 is a chart showing the circuit structure of the switching circuit 14 according to the forth embodiment of the present invention; and

FIG. 30 is a timing chart of switching signals SDA1 to SDA6 according to the forth embodiment of the present invention.

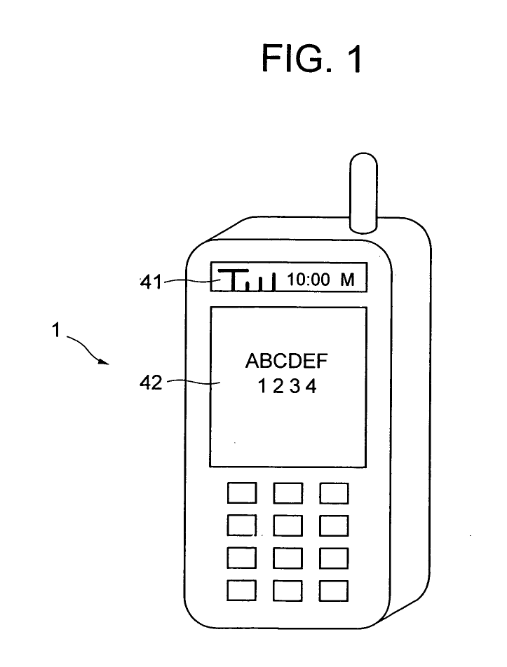

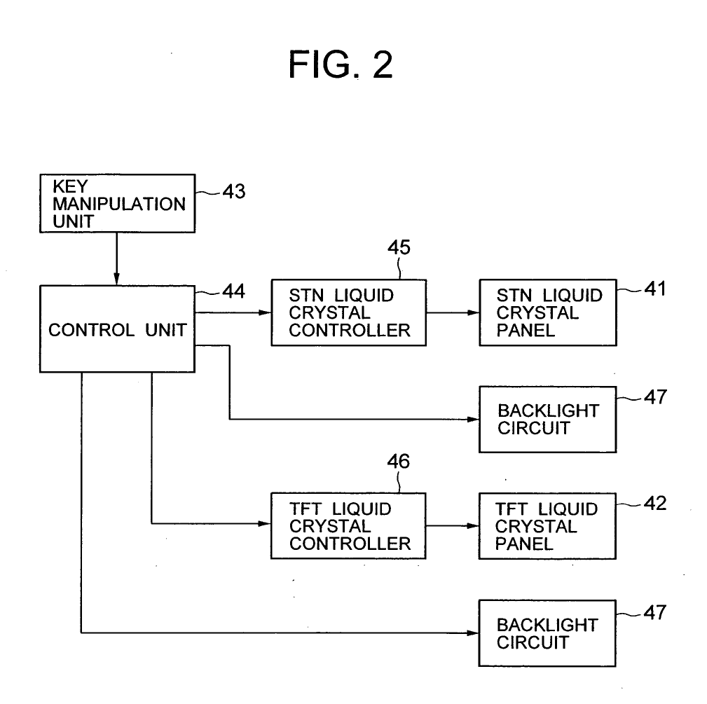

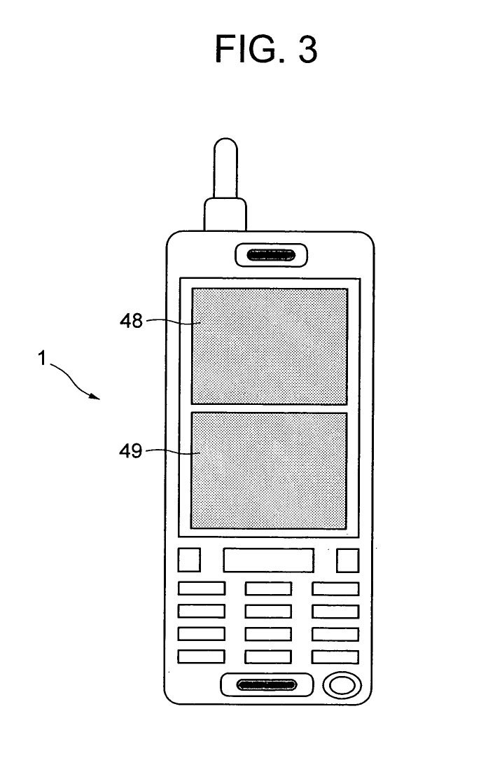

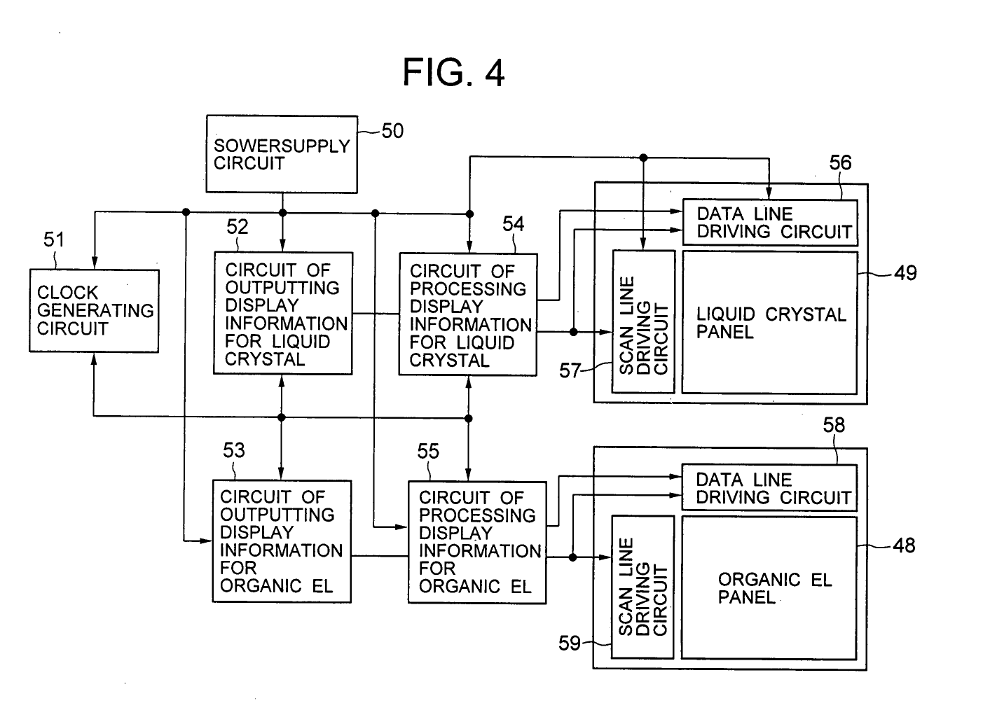

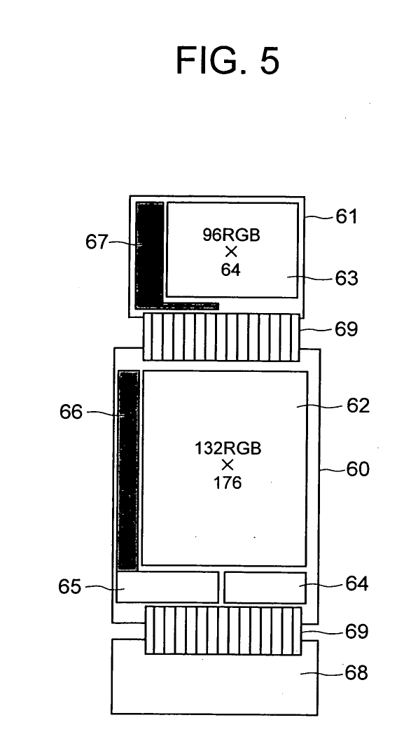

### PREFERRED EMBODIMENTS OF THE INVENTION

Embodiments of the present invention will be described below in detail with reference to the drawings.

### First Embodiment

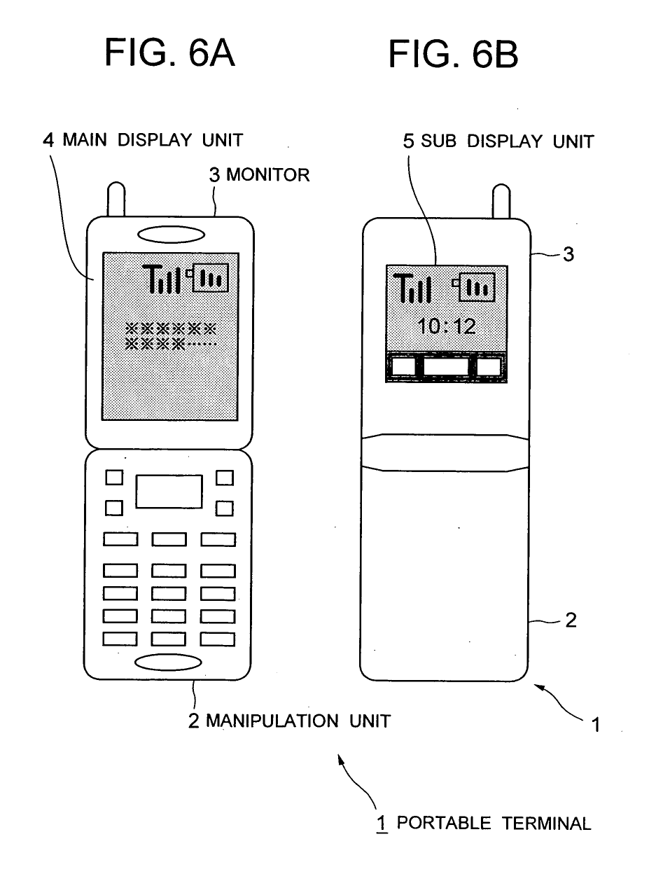

FIGS. 6A and 6B are schematic diagrams showing electronic equipment of the present invention. FIGS. 6A and 6B show an example of a portable telephone in which a main display unit and a sub display unit are mounted, as electronic equipment. FIG. 6A shows the state of the portable telephone being used, viewed from the front side. FIG. 6B shows the state of the portable telephone being used, viewed from the back side.

As shown in FIGS. 6A and 6B, a portable telephone 1 includes a manipulation unit 2 and a monitor 3 connected with each other so as to be openable/closable. The manipulation unit 2 is provided with various key buttons. In the front face of the monitor 3, a main display unit 4 is mounted, and in the back face of the monitor 3, a sub display unit 5 is mounted. The key buttons of the manipulation unit 2 are provided in the front face of the manipulation unit 2 on the side of the main display unit 4.

The portable telephone 1 shown in FIGS. 6A and 6B is so foldable that the manipulation unit 2 and the monitor 3 are folded into two. In the folded state, the screen of the sub display unit 5 is exposed outside, and the screen of the sub display unit displays various kinds of information. The screen size of the main display unit 4 is a diagonal 2.4-inche type of longitudinal 320 dots by lateral 240*RGB dots. The screen size of the sub display unit 5 is a diagonal 1-inch type of longitudinal 120 dots by lateral 160*RGB dots. The screen of the main display unit 4 shown in FIG. 6A mainly displays main information required for communications including telephone numbers, addresses, E-mail addresses, contents of E-mails transmitted or received, received information via the Internet, an antenna mark showing the field intensity, a battery mark showing the battery residue, current time, setting information of the portable telephone. The screen of the sub display unit 5 shown in FIG. 6B mainly displays information required in the standby mode, including an antenna mark showing the field intensity, a battery mark showing the battery residue, current time, sender of a received E-mail, telephone number of an incoming call. Further, each display unit 4 or 5 consists of a liquid crystal display unit of an active matrix type.

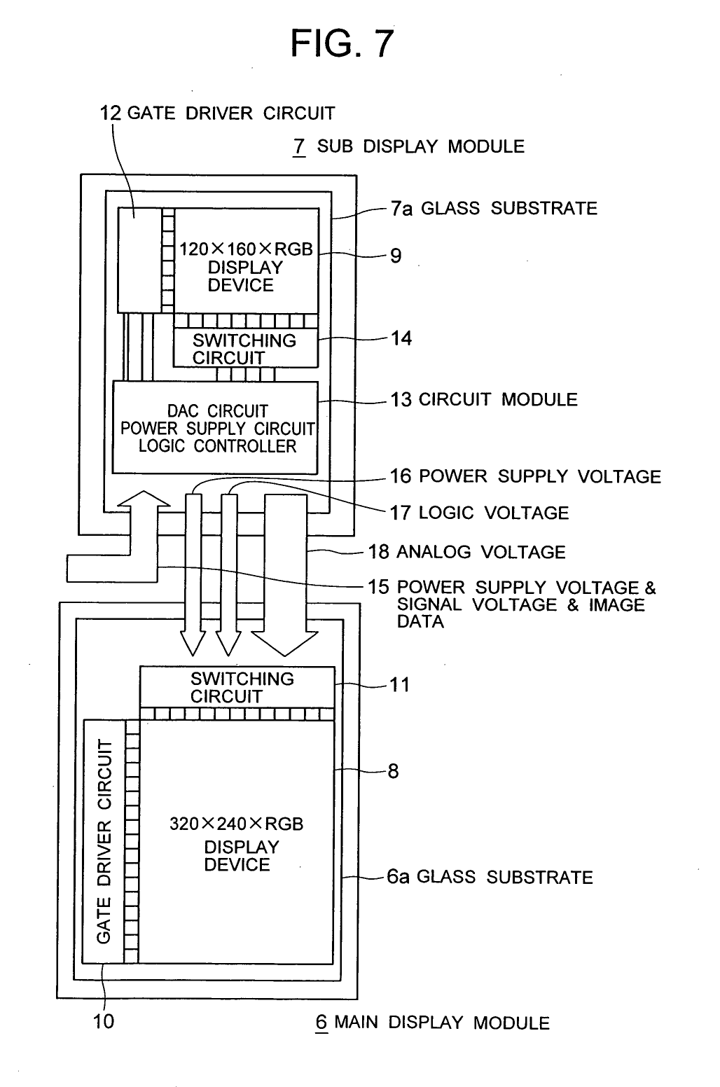

FIG. 7 is a block diagram showing the display system consisting of the main display unit 4 and the sub display unit 5.

As shown in FIG. 7, in the display system of the present embodiment, the main display unit 4 shown in FIG. 6A is configured as a display unit provided with a main display module 6 formed on a glass substrate (insulating substrate) 6a. The sub display unit 5 shown in FIG. 6B is configured as a display unit provided with a sub display module 7 formed on a glass substrate (insulating substrate) 7a.

The main display module 6 includes a display device 8 formed on the insulating substrate, and the sub display module 7 includes a display device 9 formed on the insulating substrate. Each display device 8 or 9 consists of a liquid crystal, pixels consisting of electrodes for driving the liquid crystal, thin film field effect transistors (hereinafter referred to as TFTs) serving as switches for supplying voltages to the pixels, gate bus lines for selecting TFTs connected to pixels into which displayed data is written, and data bus lines for supplying voltages applied to the pixels via the TFTs selected by the gate bus lines.

The numeral 10 indicates a gate driver circuit consisting of TFTs formed on the glass substrate 6a for supplying signals to the gate bus lines of the display device 8. The numeral 11 indicates a switching circuit consisting of TFTs formed on the glass substrate 6a for switching voltages applied to the data bus lines of the display device 8. The numeral 12 indicates a gate driver circuit consisting of TFTs formed on the glass substrate 7a for supplying signals to the gate bus lines of the display device 9. The numeral 13 indicates a circuit module of a CMOS configuration formed on the glass substrate 7a. The circuit module 13 includes a power circuit which generates a power supply voltage supplied to the display devices 8, 9, a logic controller for generating digital signals supplied to the display devices 8, 9, and a DAC circuit (digital to analog conversion circuit) which outputs display data supplied to the display devices 8, 9. The power circuit generates all voltages (power supply voltage, logic voltage and analog voltage) supplied to the main display module 6 and to the sub display module 7. The numeral 14 indicates a switching circuit consisting of TFTs formed on the glass substrate 7a for switching a destination of a voltage to be applied to the data bus lines of the display device 9. The numeral 15 indicates supply voltage, signal voltage and image data supplied form the outside of the display system for driving the display modules 6 and 7. The numeral 16 indicates a supply voltage for driving, outputted from the circuit module 13 to the main display module 6. The numeral 17 indicates a logic voltage outputted from the circuit module 13 to the main display module 6. The numeral 18 indicates an analog voltage (analog signal) as display data outputted from the circuit module 13 to the main display module 6.

Note that the gate driver circuits 10 and 12 and the switching circuits 11 and 14 consist of TFTs for high breakdown voltage in which polycrystalline silicon is used, and the circuit module 13 consists of a CMOS circuit in which polycrystalline silicon is used. The circuit module 13 consists of TFTs for high breakdown voltage and TFTs for low breakdown voltage, which are mixed. Further, switching devices in the display devices 8 and 9 also consist of polycrystalline silicon TFTs.

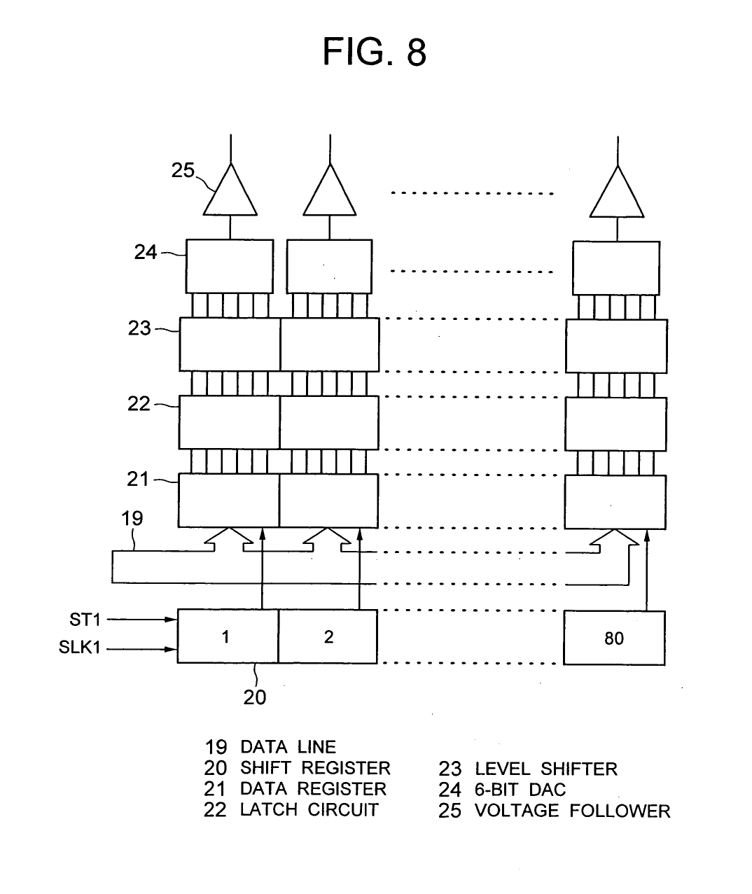

FIG. 8 is a block diagram showing the configuration of the DAC circuit contained in the circuit module 13 of the present invention. In FIG. 8, the numeral 19 indicates a data line for supplying 6-bit digital image data, and the numeral 20 indicates a shift register with 80 steps. The numeral 21 indicates a 6-bit data register by 80 pieces, for temporarily storing digital image data supplied from the data line 19. The numeral 22 indicates a 6-bit latch circuit by 80 pieces, for latching signals outputted from the data registers 21. The numeral 23 indicates a level shifter, the numeral 24 indicates a 6-bit DAC, and the numeral 25 indicates a voltage follower.

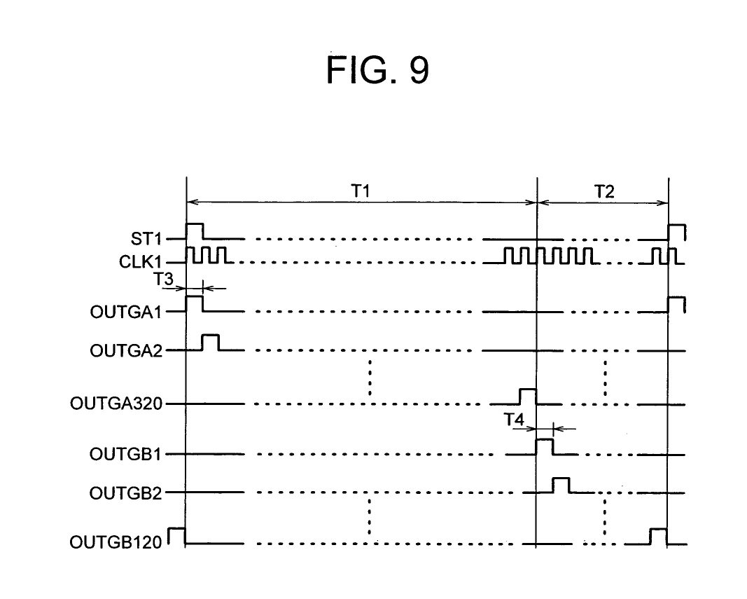

FIG. 9 is a chart showing output timings of the gate driver circuits 10 and 12 of the display system of the present embodiment. Outputs of the gate driver circuit 10 are 320 times from OUTGA1 to OUTGA320, and outputs of the gate driver circuit 12 are 120 times from OUTGB1 to OUTGB120. One frame period is divided into a screen rewrite period T1 for the main display unit 4 and a screen rewrite period T2 for the sub display unit 5.

In the period T1, the gate driver circuit 10 performs outputting sequentially shown as OUTGA1, OUTGA2, and so on, according to a start pulse ST1 and a clock signal CLK1 generated in the circuit module 13 based on the signal voltage 15 from the outside. Since the number of dots on the gate driver circuit 10 side of the main display unit 4 is 320 in the present embodiment, outputs are performed up to OUTGA320.

When the outputs have been performed up to OUTGA320, the gate drive circuit 12 of the sub display 5 operates and performs outputting sequentially. Since the number of dots on the gate driver circuit 12 side of the sub display unit 5 is 120 in the present embodiment, outputs are performed from OUTGB1 to OUTGB120.

A period T3 in FIG. 9 is a period in which one output of the gate driver circuit 10 is turned on, and a period T4 is a period in which one output of the gate driver circuit 12 is turned on. Each of the periods T3 and T4 shows a period to select a first gate bus line of the main display unit 4 or of the sub display unit 5, respectively.

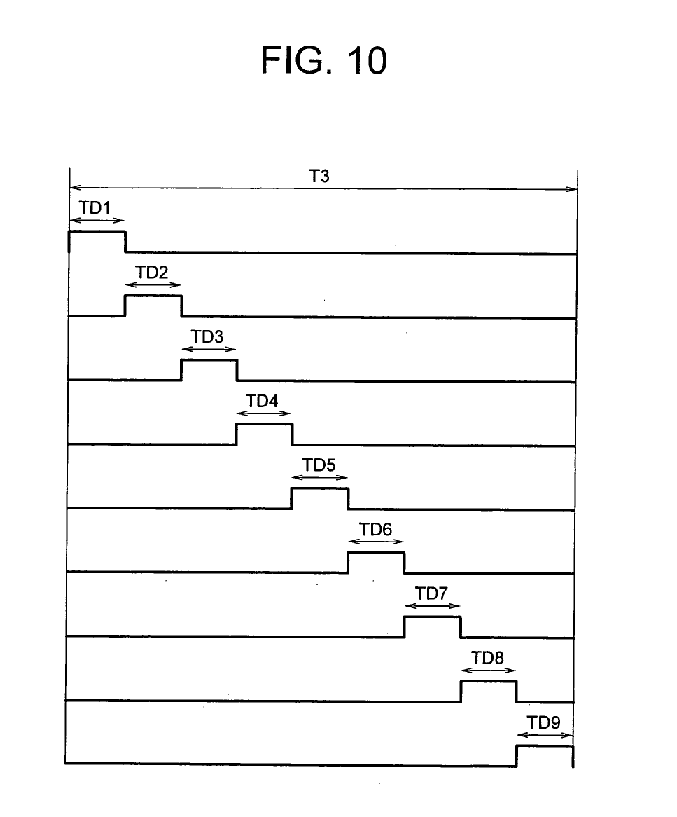

FIG. 10 is a timing chart showing the operation of the DAC circuit (see FIG. 8) in the period T3. As shown in FIG. 10, the period T3 is divided into nine periods TD1 to TD9. For example, in the period TD1 in FIG. 10, signals to be supplied to pixels at crossing parts of the first gate bus line and every nine gate bus lines from the 2nd line, that is, the 11th line, the 20th line, up to the 713th line, are transmitted in sequence. In synchronization with the data transmissions, the shift resisters shown in FIG. 8 are operated, and according to the outputs from the shift resisters 20, digital image data outputted from the data line 19 is stored in the data registers 21. Once all digital image data is stored in the 80 pieces of data registers 21 in synchronization with the period TD1, it is moved to the period TD2, and at the same time, the digital image data is transferred to the latch circuits 22 at once. The digital image data store in the latch circuits 22 is provided to the 6-bit DACs 24 through the level shifters 23 by every bit. Based on the digital image data supplied, the 6-bit DACs 24 output an analog voltage to the voltage followers 25. The voltage followers 25 amplify the current and output display data (analog signals) for the display device to the switching circuit 11. The switching circuit 11 supplies the analog voltage (display data) to the display device 8 of the main display module 6, by the switching control.

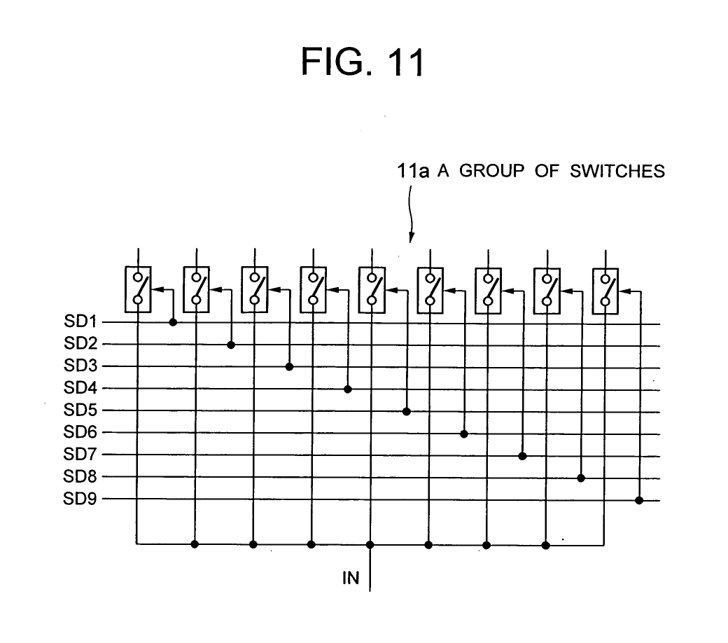

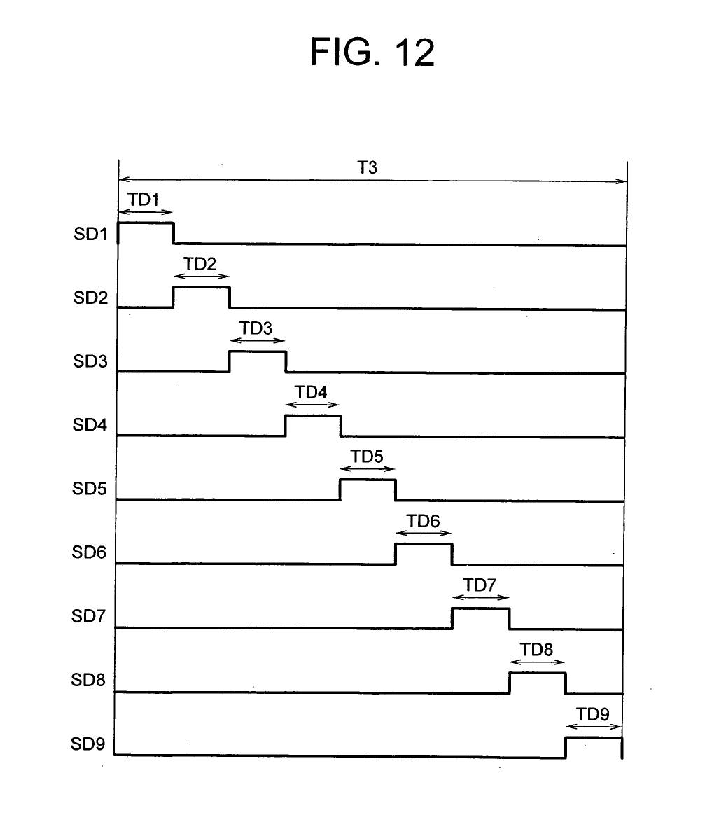

FIG. 11 is a chart showing an example of one circuit configuration among a switching circuit, containing a group of eighty switches 11a, mounted in the main display module 6, and FIG. 12 is a timing chart showing switching signals SD1 to SD9 of a group of switches 11a. Each Input terminal IN of the group of switches 11a connects with one of eighty output terminals of the voltage followers 25, respectively. Further, the output terminals of the group of switches 11a connect with a data bus line by every nine terminals sequentially. Further, the output timings of the switching signals SD1 to SD9 are synchronized with the periods TD1 to TD9. In the period TD1, a switching signal SD1 is selected, and in the period TD2, a switching signal SD2 is selected. In the same manner, the period TD3 corresponds to a switching signal SD3, and the period TD9 corresponds to a switching signal SD9, respectively. For example, in the period TD9, the signal SD2 is selected, and respective output signals (display data) of the DAC circuit are supplied to every nine data bus lines, that is, the 2nd, the 11th, the 20th, up to the 713th lines, through the switches, which are turned on, among the group of switches 11a. Here, analog signals are supplied to pixels at crossing parts of the first gate bus line and every nine data bus lines from the 2nd line, that is, the 11th, the 20th, up to the 713th lines.

In this way, digital image data to be supplied to the data bus lines during the periods TD3 to TD8 are stored sequentially in the DAC circuit shown in FIG. 7, and are converted from digital to analog, and are outputted as image data (display data) of analog signals. Along with this, in the switching circuit 11, the analog signals are switched by switches sequentially, and are supplied to the data bus lines. As for the 1st, the 10th, the 19th, up to the 712th data of the main display unit to be outputted in the period TD1, the digital image data to be supplied to the data bus lines is stored in the DAC circuit shown in FIG. 7 at the same timing as the period TD1 in the period just before the period TD1, and the data is converted from digital to analog, and outputted as image data (display data) of analog signals. Then, the image data of analog signals is supplied to the data bus lines. Further, in the period TD9, signals to be supplied to pixels at crossing parts of the 2nd gate bus line and every nine data bus lines from the 1st line, that is, the 10th, the 19th, up to the 712th lines of the main display module 6, are transmitted from the data line 19 sequentially.

In other words, by sequentially outputting the switching signals SD1 to SD9, image data of one gate bus line can be outputted to the data bus lines. By sequentially performing this operation for each gate bus line, images for one screen can be displayed on the display device 8 of the main display module 6.

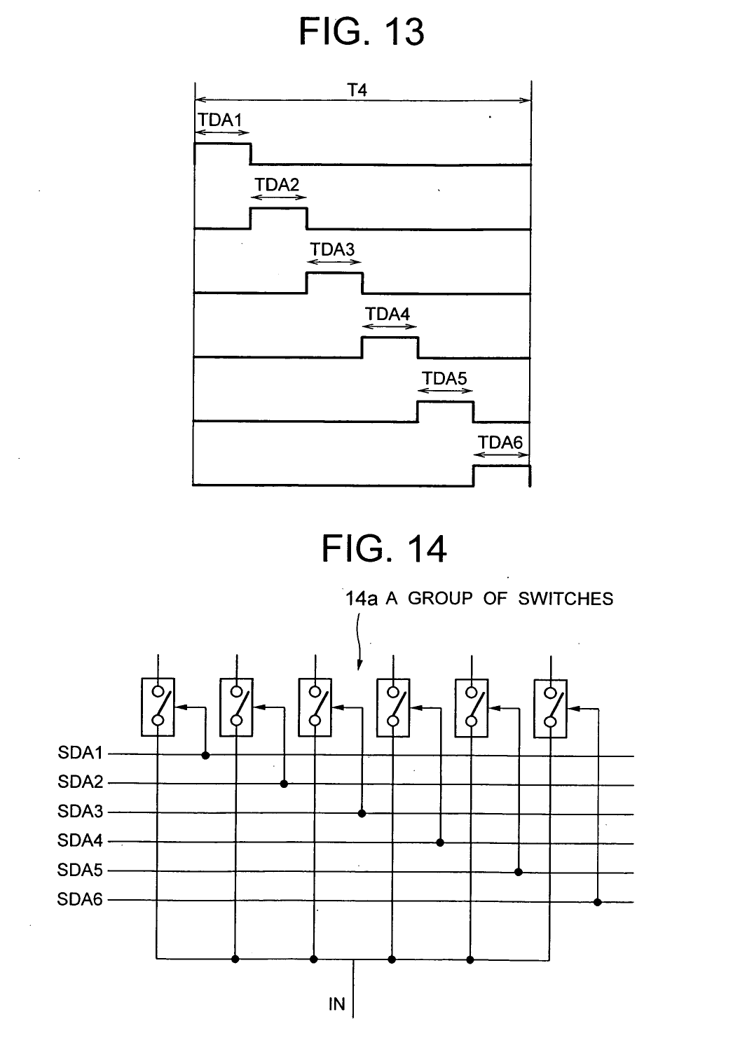

Next, an explanation will be given for a method of displaying images on the sub display module 7. FIG. 13 is a timing chart showing the operation of the DAC circuit shown in FIG. 8 in the period T4. As shown in FIG. 13, the period T4 is divided into six periods TDA1 to TDA6. For example, in the period TDA1 shown in FIG. 13, signals to be supplied to pixels at crossing parts of the 1st gate bus line and every six gate bus lines from the 2nd line, that is, the 8th, the 14th, up to the 476th line of the sub display module 7, are transmitted sequentially from the data line 19, and the shift registers 20 shown in FIG. 8 operate in synchronization with the data transmissions, so that the digital image data is stored in the data registers 21. Once all digital image data is stored in the 80 pieces of data registers 21 in synchronization with the period TDA1, it is moved to the period TD2, and at the same time, the digital image data is transferred to the latch circuits 22 at once. The digital image data stored in the latch circuits 22 is provided to the 6-bit DACs 24 through the level shifters 23 by every bit. Based on the digital image data supplied, the 6-bit DACs 24 output an analog voltage to the voltage followers 25. The voltage followers 25 amplify the current and output display data (analog signals) for the display device to the switching circuit 11. The switching circuit 11 supplies the analog voltage (display data) to the display device 9 of the sub display module 7, by the switching control.

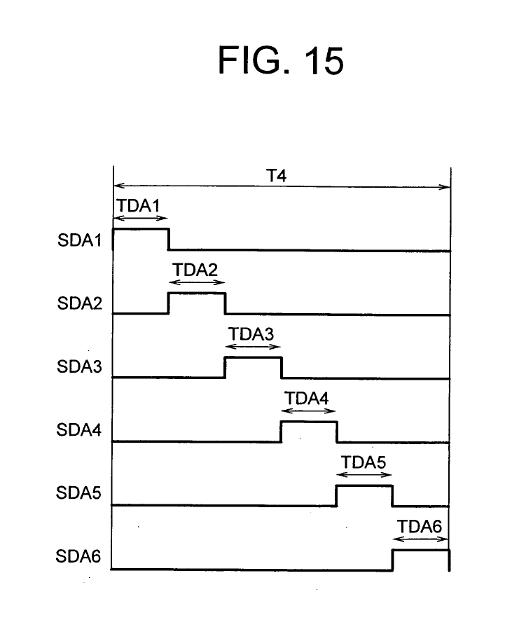

FIG. 14 is a chart showing an example of one circuit configuration among a group of eighty switches 14a contained in the switching circuit 14, and FIG. 15 is a timing chart showing switching signals SDA1 to SDA6 of a group of switches 14a. Each input terminal IN of the group of switches 14a connects with one output terminal of the voltage followers 25, respectively. Further, the output terminals of the group of switches 14a connect with a data bus line by every six terminals sequentially. Further, the output timings of the switching signals SDA1 to SDA6 are synchronized with the periods TDA1 to TDA6. In the period TDA1, a switching signal SDA1 is selected, and in the period TDA2, a switching signal SDA2 is selected. In the same manner, the period TDA3 corresponds to a switching signal SDA3, and the period TDA6 corresponds to a switching signal SDA6, respectively. For example, in the period TDA2, the signal SDA2 is selected, and respective output signals (display data) from the DAC circuit are supplied to every six data bus lines from the 2nd line, that is, the 8th, the 14th, up to the 476th lines, through switches, which are turned on, among the group of switches 14a. Here, analog signals (display data) are supplied to pixels at crossing parts of the 1st gate bus line and every six data bus lines from the 2nd line, that is, the 8th, the 14th, up to the 476th lines, of the sub display module 7.

In this way, digital image data to be supplied to the data bus lines during the periods TDA3 to TDA6 are stored sequentially in the DAC circuit shown in FIG. 7, and are converted from digital to analog, and are outputted as image data (display data) of analog signals. Along with this, in the switching circuit 14, the analog signals are switched by switches sequentially and are supplied to the data bus lines. As for the 1st, the 7th, the 13th, up to the 475th data of the sub display unit to be outputted in the period TDA1, the digital image data to be supplied to the data bus lines is stored in the DAC circuit shown in FIG. 7 at the same timing as the period TDA1 in a period just before the period TD1, and the data is converted from digital to analog, and outputted as image data (display data) of analog signals. Then, the image data of analog signals is supplied to the data bus lines. Further, in the period TDA6, signals to be supplied to the pixels at the crossing parts of the 2nd gate bus line and every six data bus lines from the 1st line, that is, the 7th, the 13th, up to the 475th lines of the sub display module 7, are transmitted from the data line 19 sequentially.

In other words, by sequentially outputting the switching signals SDA1 to SDA6, image data of one gate bus line can be outputted to the data bus lines. By sequentially performing this operation for each gate bus line, images for one screen can also be displayed on the sub display module 7.

In the present invention, only the gate drive circuit 10 and the switching circuit 11 with simple circuit configurations are formed on the main display module 6 side having large number of pixels and large screen area. Thereby, it is possible to make the trim area of the main display module small, which leads to a compact configuration of the display system. Further, since the main display module 6 consists solely of TFTs for high breakdown voltage, the manufacturing process is simplified, so that it is possible to expect an improvement in yield.

Note that although a case where all three kinds of signals such as the supply voltage 15, the logic voltage 16 and the analog voltage 17 are supplied from the sub display module 7 to the main display module 6 has been explained in the present embodiment, the present invention is not limited to this aspect. Any one or two kinds among the supply voltage, the logic voltage and the analog voltage may be supplied from the sub display module 7 to the main display module 6, and the others may be supplied by different means.

Further, although a case of two display modules being provided has been explained in the present embodiment, the display system of the present invention may be configured of three or more display modules. If there are three or more display modules, at least one display module should be supplied with a voltage from the sub display module 7 in accordance with the present invention.

Further, in the present invention, the display areas and the number of pixels of two display units are not limited. However, in the present embodiment, the display area of the display device of the sub display unit is smaller than that of the main display unit, and the free space around the sub display is large with reference to the casing. Therefore, by mounting a circuit for driving the main display unit in this space, it is possible to reduce the size of the display system comparing with a method in which the circuit is disposed around the main display unit. This enables to design the casing of the portable telephone monitor 3 to be small.

Further, although the main display unit 4 and the sub display unit 5 shown in the present embodiment are configured to display image data in such a manner that the TFTs are driven and output display driving signals to thereby drive the LCDs, the present invention is not limited to this aspect. Alternatively, a display device such as an organic EL display may be used. In such a case, it is obvious that the similar effect is achieved. Further, the main display unit 4 on the side where signals are supplied can achieve the similar effect with the active matrix type LCD using diodes or amorphous silicon as pixels.

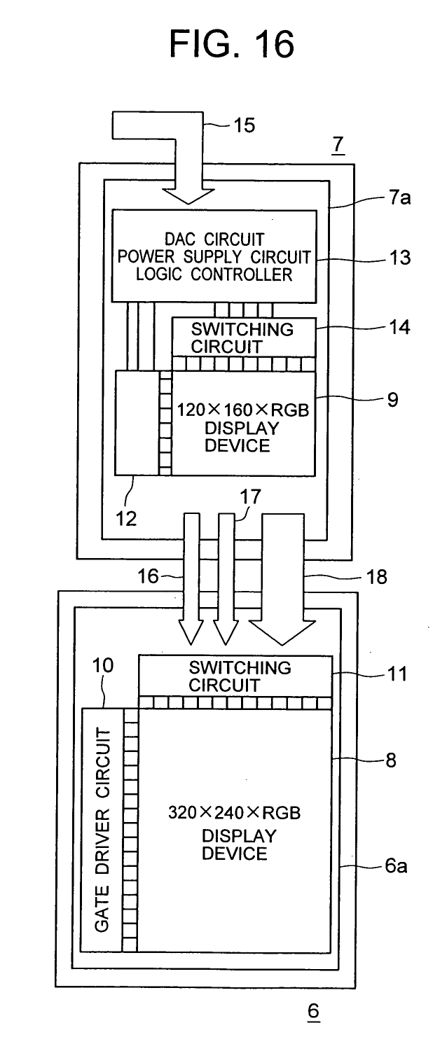

In FIG. 7, supply of the voltages from the sub display module 7 to the main display module 6 is performed through a flat cable connected between the both substrates, for example. The flat cable can be provided in the position where the arrows 16 to 18 are indicated, that is, between the main display module 6 and the sub display module. In the present embodiment, although the circuit module 13 is disposed between the display device 8 of the main display unit and the display device 9 of the sub display unit (the display device 8 and the display device 9 are provided on the different sides of the circuit module 13), the display device 8 of the main display unit and the display device 9 of the sub display units may be provided on the same side of the circuit module 13, as shown in FIG. 16. In this case, at least a part of the voltage for driving the display device 8 can be set to be transmitted via wiring passing through the display device 9.

Further, the number of gate bus lines and data bus lines of respective display devices are not limited to those described in the aforementioned embodiment, and also the timings of respective signals are not limited to those shown as examples provided that they perform the same operations.

### Second Embodiment

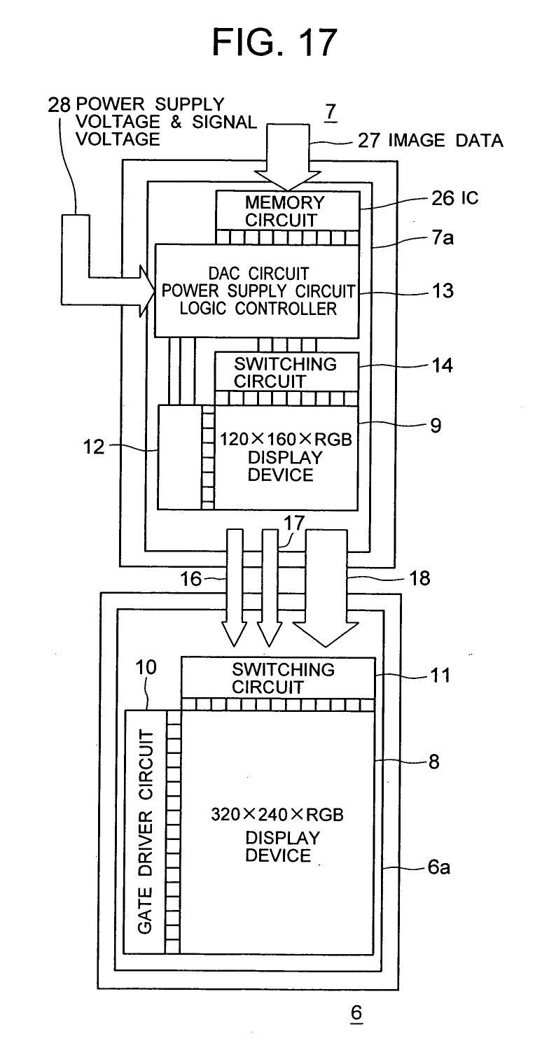

FIG. 17 is a block diagram showing the configuration of a display system consisting of the main display unit 4 and the sub display unit 5 according to a second embodiment of the present invention. In FIG. 17, the parts having the same functions as those of the parts in the first embodiments are denoted by the same reference numerals and repetition of the explanation is omitted.

In FIG. 17, the numeral 28 indicates a supply voltage and a signal voltage supplied from the outside of the present display system for driving the display modules. The numeral 26 indicates an IC (integrated circuit chip) on which a memory circuit for storing image data is mounted. The numeral 27 indicates image data supplied from the outside of the present display system to the IC 26.

The IC 26 can be configured of general, low-priced memories, and is mounted on the glass substrate 7a by the COG (chip on glass) method. The IC 26 may be mounted by the TAB (tape automated bonding) method or may be mounted by disposing a CSP (chip size package) device.

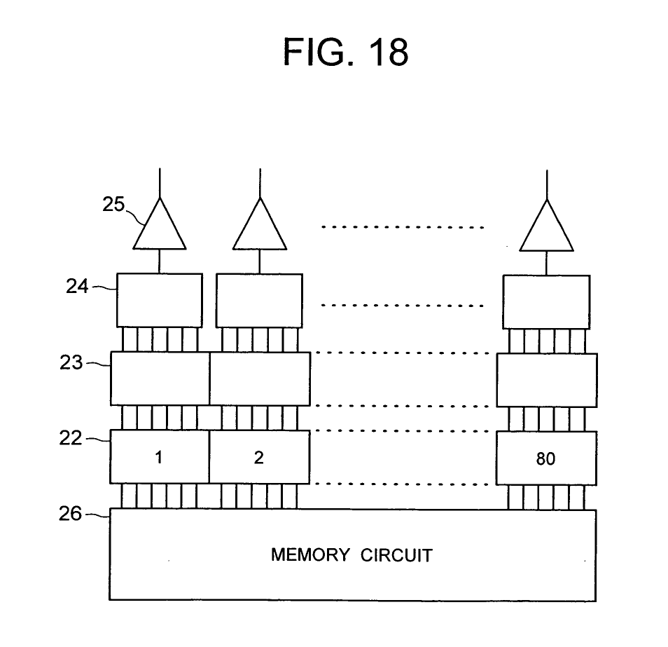

FIG. 18 is a block diagram showing the connection of the DAC circuit in the circuit module 13 and the IC 26. In FIG. 18, the numeral 22 indicates a 6-bit latch circuit by 80 pieces, the numeral 23 indicates a level shifter, the numeral 24 indicates a 6-bit DAC, and the numeral 25 indicates a voltage follower.

The selection timings of the gate driver circuit, the operating timings of the DAC circuit, and the configuration of the switching circuit are same as those in the first embodiment shown in FIGS. 9 to 15, whereby they are not shown and repetition of the explanation is omitted.

In the circuit shown in FIG. 18, in the period TD1 shown in FIG. 10, for example, signals to be supplied to pixels at crossing parts between the 1st gate bus line and the every nine gate bus lines from the 2nd line, that is, the 10th, the 19th, up to the 712th lines of the display device 8 in the main display module 6, are transmitted from the memory circuit (IC 26), and at the same time, this data is transferred to the latch circuits 22 at once. The digital image data stored in the latch circuits 22 is supplied to the 6-bit DACs24 through the level shifters 23 by every bit. Based on the digital image data supplied to the 6-bit DACs 24, an analog voltage (display data) to be supplied to the main display unit is outputted.

In the DAC circuit of the first embodiment shown in FIG. 8, the shift registers 20 are operated to thereby sequentially store the 6-bit image data to 80 pieces of data registers 21, which requires high-speed data transfer. On the other hand, in the present embodiment, image data is transmitted at once from the memory circuit of the IC 26 shown in FIG. 17 to the DAC circuit shown in FIG. 17, as described above. Thereby, it is possible to significantly reduce the transfer frequency of the image data, which leads to a reduction in the power consumption. Further, there is no access to the memory circuit (IC 26) unless image data is rewritten from the outside, whereby there is no need to develop image data transferred from the outer circuit at a high speed for inner circuits. This also leads to a reduction is the power consumption.

Further, although a configuration in which a memory circuit (IC 26) for storing image data for both the sub display unit and the main display unit has been shown in the present embodiment, the present invention is not limited to this configuration. It is obvious that the similar effect can be achieved by storing image data for either the sub display unit or the main display unit in the memory circuit (IC 26) and supplying image data not stored in the memory circuit (IC 26) from the outside.

Note that the present embodiment can also enjoy the effect achieved in the first embodiment, in addition to the effect described above. Further, the modifications of the embodiment shown in the description of the first embodiment can be adopted as modifications of the present embodiment.

### Third Embodiment

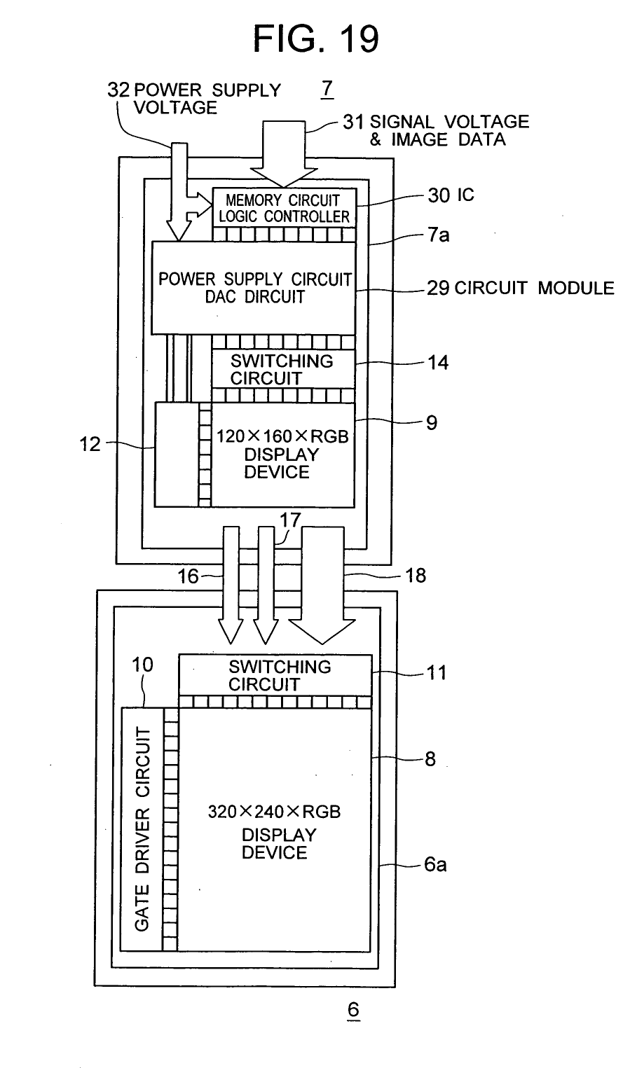

FIG. 19 is a block diagram showing the configuration of a display system consisting of the main display unit 4 and the sub display unit 5 according to a third embodiment. In FIG. 19, parts having the same function as those of parts in the second embodiment are denoted by the same reference numerals, and repetition of the explanation is omitted.

In FIG. 19, the numeral 29 indicates a circuit module with the CMOS configuration, which is formed on the glass substrate 7a and has a power supply circuit and a DAC circuit which generate a supply voltage and an analog voltage to be supplied to the main display module 6 and to the sub display module 7. The numeral 30 indicates an IC (integrated circuit chip) on which a memory circuit for storing image data and a logic controller which generates a logic voltage to be supplied to the main display module 6 and the sub display module 7 are mounted. The numeral 31 indicates a signal voltage and image data to be supplied to the IC 30 from the outside of the present display system. The numeral 32 indicates a power supply voltage to be supplied to the circuit module 29 and to the IC 30 from the outside of the present display system.

Each of the memory circuit and the logic controller mounted on the IC 30 can consist solely of transistors for low breakdown voltage. Therefore, the IC 30 can be formed at relatively low price although different functions are provided. Although the IC 30 is mounted by the COG method in the present embodiment, it may be mounted by the TAB method. Alternatively, a CSP device may be mounted on the glass substrate 7a.

In the present embodiment, the circuit module 29 can consist solely of TFTs for high breakdown voltage. Therefore, all TFTs formed on the glass substrate, including the gate driver circuit 12 and the switching circuit 14, are of high breakdown voltage, whereby a process of forming thin film transistors is simplified, so that it is possible to expect an improvement in yield.

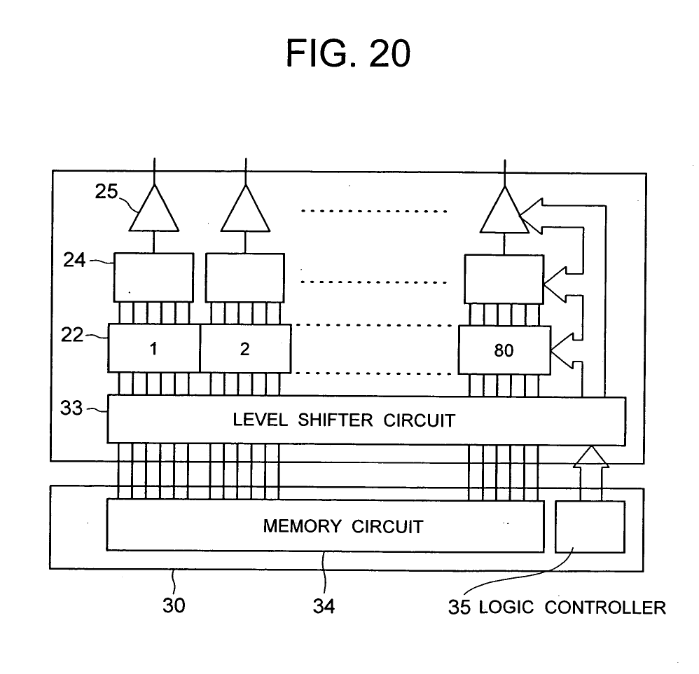

FIG. 20 is a block diagram showing the connection of the DAC circuit in the circuit module 29 and the IC 30 mounted by the COG of the present invention. In FIG. 20, the numeral 22 indicates a 6-bit latch circuits by 80 pieces, the numeral 24 indicates a 6-bit DAC, and the numeral 33 indicates a level shifter circuit for converting signals supplied with a low voltage into a voltage for driving the display units. The numeral 30 indicates an IC, the numeral 34 indicates a memory circuit of the IC 30 for storing image data, and the numeral 35 indicates a logic controller of the IC 30, which generates signals for driving the display units from signals supplied form the outside.

The selection timings of the gate driver circuit, the operational timings of the DAC circuit, and the switching circuit structure of the present embodiment are similar to those of the first embodiment shown in FIGS. 9 to 15, whereby they are not shown and repetition of the explanation is omitted.

In the circuits shown in FIG. 20, in the period TD1 shown in FIG. 10, for example, signals to be supplied to pixels at crossing parts between the 1st gate bus line and every nine gate bus lines from the 2nd line, that is, the 10th, the 19th, up to the 712th lines of the main display module 6, are transmitted from the memory circuit 34, and a voltage conversion is performed by the level shifter circuit 33, and the signals are transferred to the latch circuits 22 at once. The digital image data stored in the latch circuits 22 are supplied to the 6-bit DACs 24. Based on the digital image data supplied, the 6-bit DACs 24 output an analog voltage (display data) to be supplied to the main display unit. Here, signals from the logic controller 35 for driving respective circuits are also supplied through the level shifter circuit 33.

In the DAC circuit of the first embodiment shown in FIG. 8, the shift registers 20 are operated so as to sequentially store 6-bit image data into the 80 pieces of data registers 21, whereby high-speed data transfer is required. In contrast, in the present embodiment, image data is transmitted at once from the memory circuit 34 to the level shifter circuit 33 as described above, whereby it is possible to significantly reduce transfer frequency of the image data like the case of the second embodiment, and to reduce the power consumption as well. Further there is no access to the memory circuit 34 unless the image data is rewritten from the outside, whereby there is no need to develop image data transferred at a high speed from outer circuits for inner circuits, which also leads to a reduction in the power consumption.

Note that the present embodiment can enjoy the effect achieved in the first embodiment, in addition to the effect described above. Further, the modification of the embodiment shown in the description of the first embodiment can also be adopted as modifications of the present embodiment.

### Forth Embodiment

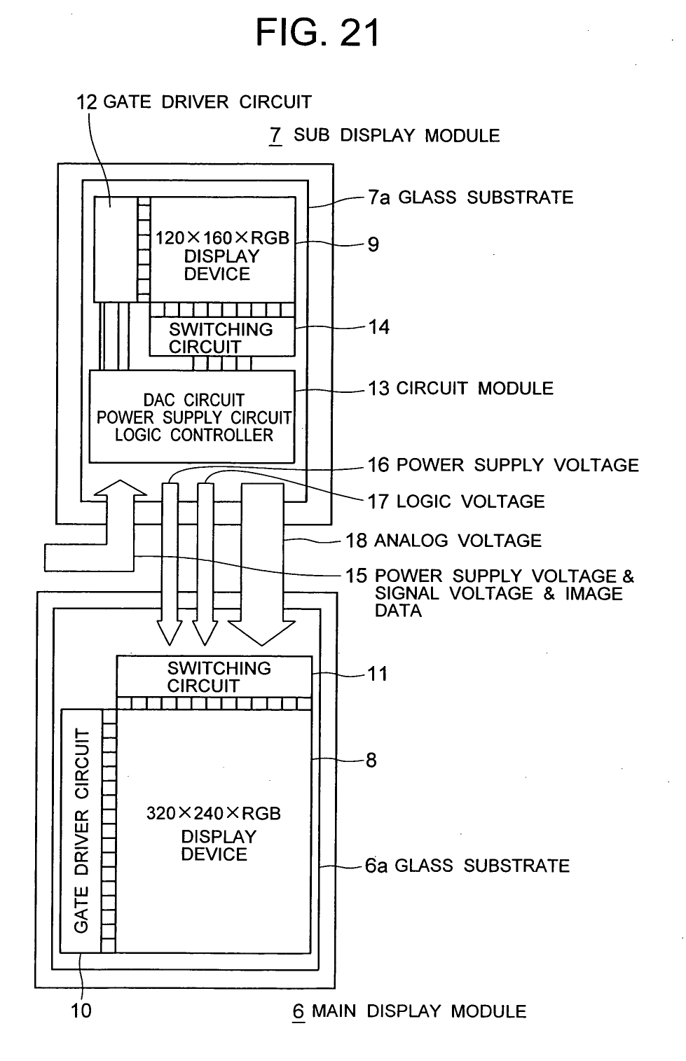

FIG. 21 is a block diagram showing the configuration of a display system consisting of the main display unit and the sub display unit according to a forth embodiment of the present invention. In FIG. 21, the numeral 6 indicates a main display module, the numeral 7 indicates a sub display module, the numeral 8 indicates a display device of the main display module 6, in which a switching device consists of p-channel TFTs, and the numeral 9 indicates a display device of the sub display module 7. Each display device includes pixels consisting of liquid crystal and electrodes for driving the liquid crystal, TFTs serving as switches for supplying voltages to the pixels, gate bus lines for selecting TFTs connected with pixels onto which display data is written, and data bus lines for supplying voltages to be applied to the pixels via the TFTs selected by the gate bus lines. The numeral 10 indicates a gate driver circuit consisting of p-channel TFTs formed on the glass substrate for supplying signals to the gate bus lines of the display device 8, and the numeral 11 indicates a switching circuit consisting of p-channel TFTs formed on the glass substrate for switching destinations of voltages to be applied to the data bus lines of the display device 8. The numeral 12 indicates a gate driver circuit consisting of p-channel TFTs formed on the glass substrate for supplying signals to the gate bus lines of the display device 9, and the numeral 13 indicates a circuit module with the CMOS structure formed on the glass substrate for generating a supply voltage, an analog voltage and a logic voltage to be supplied to the main display module 6 and to the sub display module 7. The numeral 14 indicates a switching circuit formed of the TFTs on the glass substrate for switching destinations of the voltages to be applied to the data bus lines of the display device 9. The numeral 15 indicates a supply voltage, a signal voltage and image data supplied from the outside for driving the display module, and the numeral 16 indicates a supply voltage generated by the circuit module 13 of the sub display unit for driving the main display module. The numeral 17 indicates a logic voltage generated by the circuit module for driving the main display module, and the numeral 18 indicates an analog voltage generated by the circuit module 13 for driving the main display module.

The screen size of the display device 8 is a diagonal 2.4-inche type of longitudinal 320 dots by lateral 240*RGB dots. The screen size of the display device 9 is a diagonal 1-inch type of longitudinal 120 dots by lateral 160*RGB dots. The display device 8 of the main display module 6 mainly displays main information required for communications such as telephone numbers, addresses, E-mail addresses, contents of E-mails transmitted or received, received information via the Internet, an antenna mark showing the field intensity, current time, setting information of the portable telephone. The display device 9 of the sub display module 7 mainly displays information required in the standby mode, such as an antenna mark showing the field intensity, a battery mark showing the battery residue, current time, sender of a received E-mail, telephone number of an incoming call. Further, each display device consists of a liquid crystal display unit of an active matrix type.

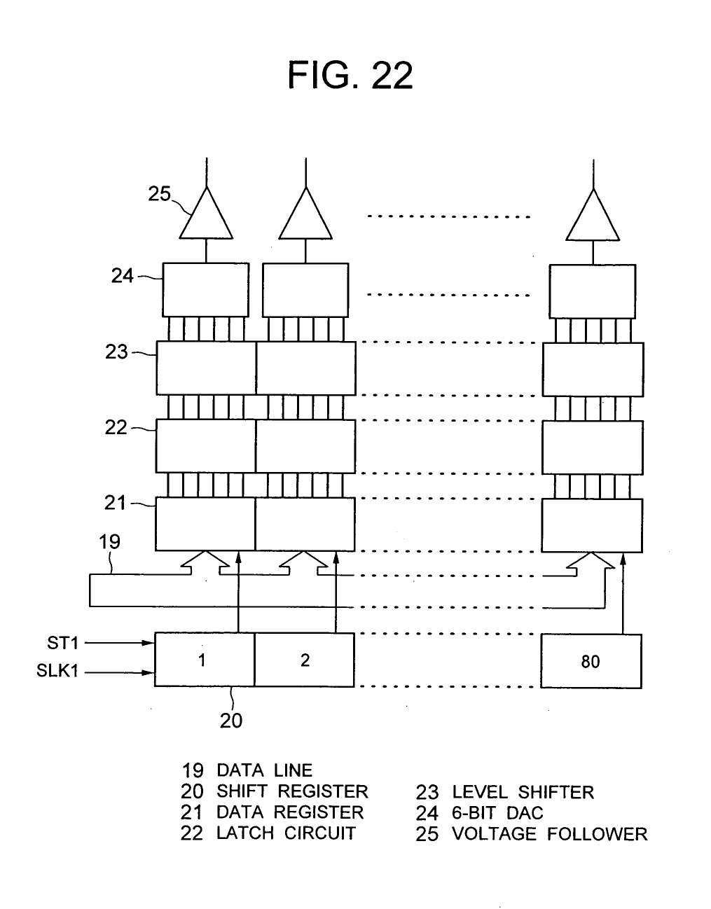

FIG. 22 is a block diagram showing the configuration of the DAC circuit contained in the circuit module 13. In FIG. 22, the numeral 19 indicates a data line for supplying 6-bit digital image data, and the numeral 20 indicates a shift register with 80 steps. The numeral 21 indicates a 6-bit data register by 80 pieces, for temporarily storing digital image data. The numeral 22 indicates a 6-bit latch circuit by 80 pieces, the numeral 23 indicates a level shifter, the numeral 24 indicates a 6-bit DAC, and the numeral 25 indicates a voltage follower.

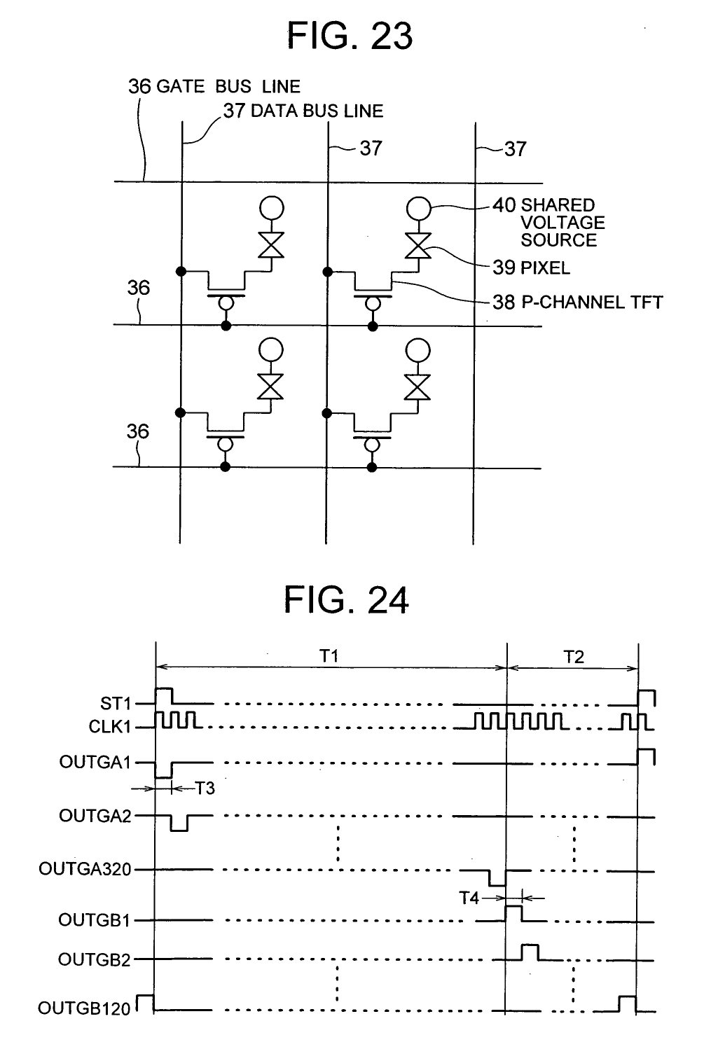

FIG. 23 is a circuit diagram showing the configuration of a pixel unit of the main display unit. In FIG. 23, the numeral 36 indicates a gate bus line sequentially selected by the gate driver circuit 10, and the numeral 37 indicates a data bus line for supplying an analog voltage for image data to pixels. The numeral 38 indicates a p-channel TFT serving as a switch for applying signals from the data bus lines 37 to pixels when the gate bus lines are selected. The numeral 39 indicates a pixel consisting of liquid crystal, and the numeral 40 indicates a common voltage source to be applied for determining voltages on both ends of the pixel.

FIG. 24 is a chart showing output timings of the gate driver circuits 10 and 12 of the display system of the present embodiment. Outputs of the gate drive circuit 10 are 320 times from OUTGA1 to OUTGA320, and outputs of the gate driver circuit 12 are 120 times from OUTGB1 to OUTGB120. One frame period is divided into a screen rewrite period T1 of the main display unit 4 and a screen rewrite period T2 of the sub display unit 5. In the period T1, the gate driver circuit 10 performs output in sequential order shown as OUTGA1, OUTGA2, and so on, according to a start pulse ST1 and a clock signal CLK1 generated in the circuit module 13 based on the signal voltage (included in 15) from the outside. Since the number of dots on the gate driver circuit 10 side of the main display unit 4 is 320 in the present embodiment, outputs are performed up to OUTGA320. When the outputs have been performed up to OUTGA320, the gate drive circuit 12 of the sub display 5 is operated and performs outputs sequentially. Since the number of dots on the gate driver circuit 12 side of the sub display unit 5 is 120 in the present embodiment, outputs are performed from OUTGB1 to OUTGB120. The period T3 in FIG. 24 is a period in which one output of the gate driver circuit 10 is turned on, and the period T5 is a period in which one output of the gate driver circuit 12 is turned on. Each of the periods T3 and T4 shows a period to select a first gate bus line of the main display unit 4 or the sub display unit 5, respectively.

Since the pixel unit of the main display unit consists of the p-channel TFTs, in the main display unit, when a gate bus line is selected, the output voltage is in a low level, and when nothing is selected, it is in a high level, as shown in FIG. 24.

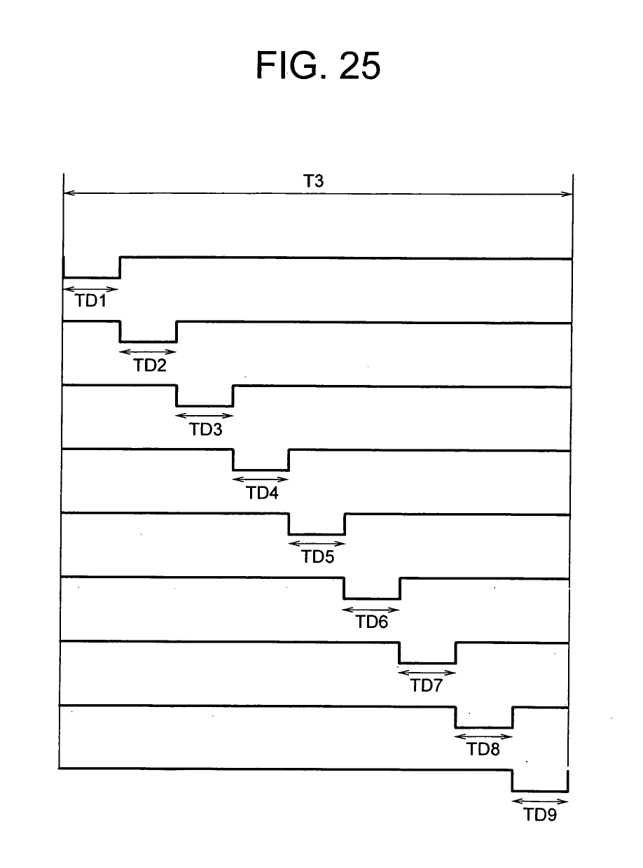

FIG. 25 is a timing chart showing the operation of the DAC circuit in the period T3. As shown in FIG. 25, the period T3 is divided into nine periods TD1 to TD9. For example, in the period TD1 in FIG. 25, signals to be supplied to pixels at crossing parts between the first gate bus line and every nine gate bus lines from the 2nd line, that is, the 11th line, the 20th line, up to the 713th line of the main display module 6, are transmitted in sequence. In synchronization with the data transmissions, the shift resisters 20 shown in FIG. 22 are operated, and digital image data outputted from the data line 19 is stored in the data registers 21. Once all digital image data is stored in the 80 pieces of data registers 21 in synchronization with the period TD1, it is moved to the period TD2, and at the same time, the digital image data is transferred to the latch circuits 22 at once. The digital image data store in the latch circuits 22 is provided to the 6-bit DACs 24 through the level shifters by every bit. Based on the digital image data supplied, the 6-bit DACs 24 output an analog voltage to be supplied to the main display unit in the period TD2.

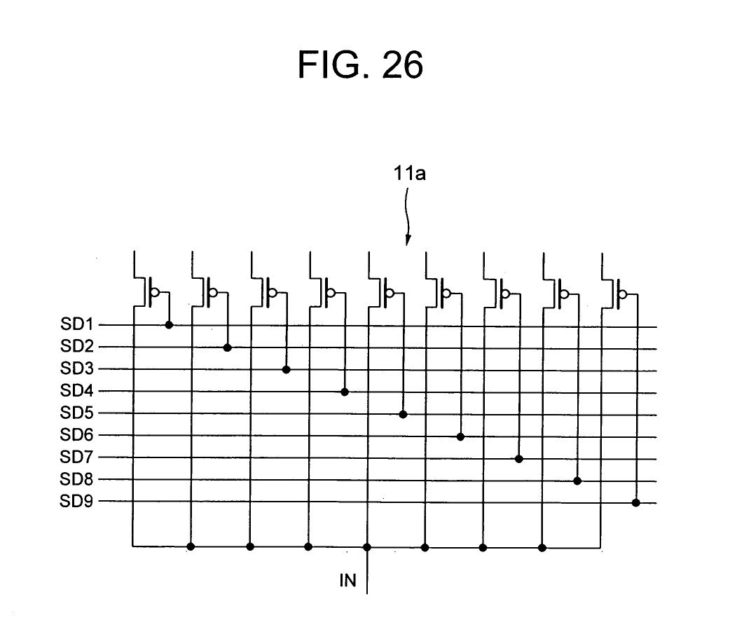

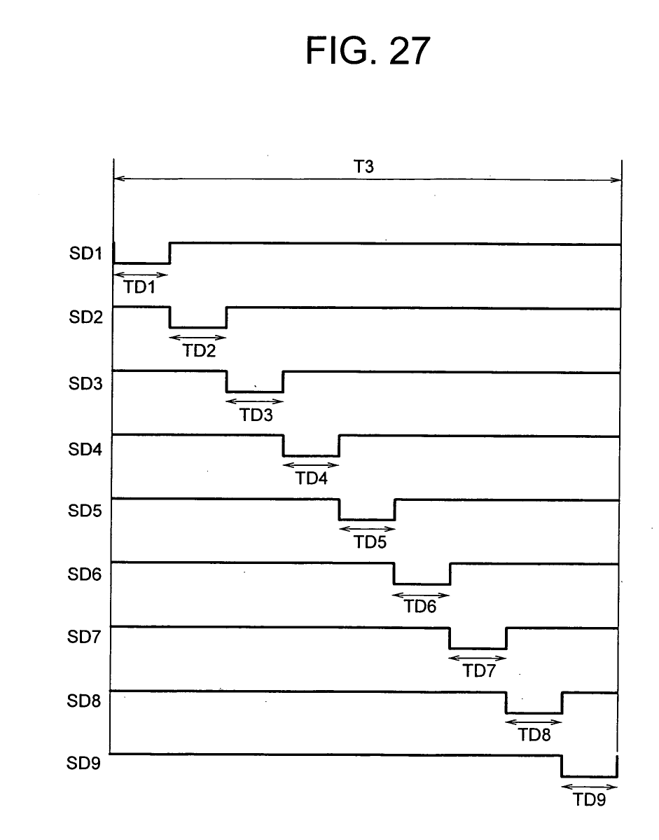

FIG. 26 is a chart showing the circuit configuration of a group of switches 11a among the switching circuits containing eighty groups of switches 11a, and FIG. 27 is a timing chart of switching signals SD1 to SD9 of a group of switches 11a. An input terminal IN of the group of switches 11a connects with one output terminal among eighty DACs, respectively. Further, the output terminals of the group of switches 11a connect with a data bus line for every nine terminals sequentially.

The switching signals SD1 to SD9 are synchronized with the periods TD1 to TD9. In the period TD1, a switching signal SD1 is selected, and in the period TD2, a switching signal SD2 is selected. In the same manner, the period TD3 corresponds to a switching signal SD3, and the period TD9 corresponds to a switching signal SD9, respectively. For example, in the period TD2, the signal SD2 is selected, and respective output signals (display data) of the DACs 24 are supplied to every nine data bus lines, that is, the 2nd, the 11th, the 20th, up to the 713th lines, through the switches, which are turned on, in the switching circuit. Here, analog signals (display data) are supplied to pixels at the crossing parts of the first gate bus line and every nine data bus lines from the 2nd line, that is, the 11th, the 20th, up to the 713th lines of the main display module 6.

In this way, during the periods TD3 to TD8, digital image data to be supplied to the data bus lines are stored sequentially, and are converted from digital to analog, and are outputted. When the image data of analog signals are inputted in the switching circuit 11, the analog signals are switched by switches sequentially and are supplied to the data bus lines. As for the 1st, the 10th, the 19th, up to the 712th data of the main display unit to be outputted in the period TD1, the digital image data to be supplied to the data bus lines is stored at the same timing as the period TD1 in a period just before the period TD1, and the data is converted from digital to analog, and outputted to the data bus lines. Further, in the period TD9, signals to be supplied to the pixels at the crossing parts of the 2nd gate bus line and every nine data bus lines from the 1st line, that is, the 10th, the 19th, up to the 712th lines of the main display module 6, are transmitted from the data line 19 sequentially.

In other words, by sequentially outputting the switching signals SD1 to SD9, image data of one gate bus line can be outputted to the data bus lines. By sequentially performing this operation for each gate bus line, images for one screen can be displayed on the display device 8 of the main display module 6.

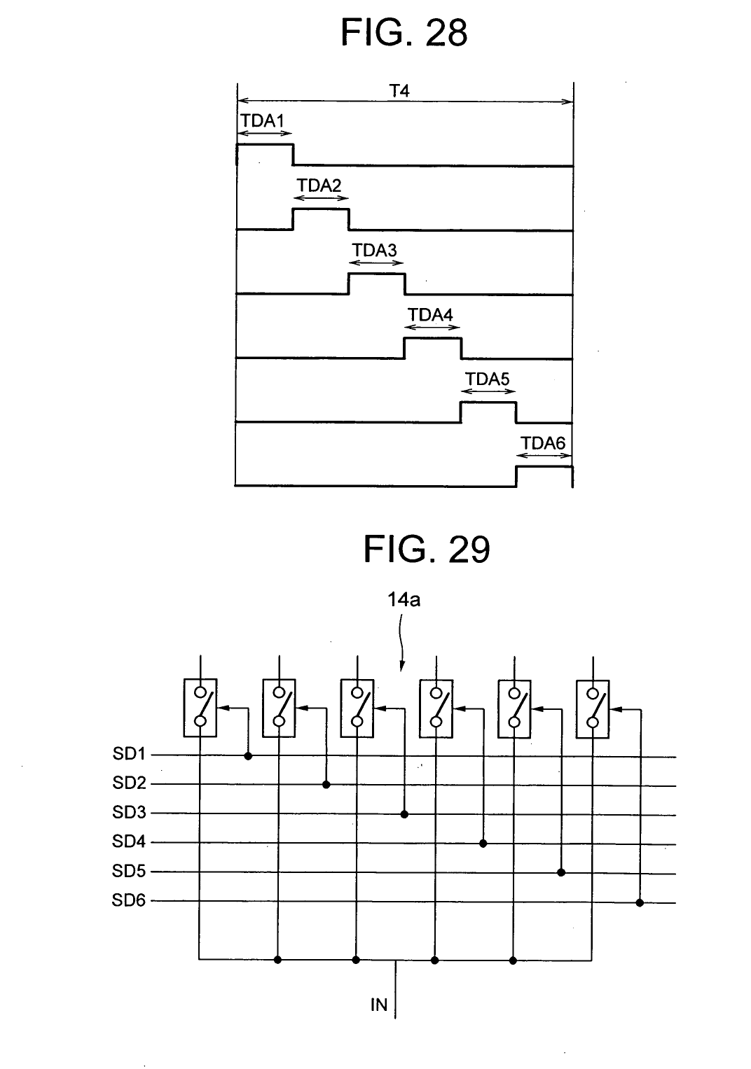

Next, an explanation will be given for a method of displaying images on the sub display module 7. FIG. 28 is a timing chart showing the operation of the DAC circuit in the period T4. As shown in FIG. 28, the period T4 is divided into six periods TDA1 to TDA6. For example, in the TDA1 shown in FIG. 28, signals to be supplied to pixels at crossing parts between the 1st gate bus line and every six gate bus lines from the 2nd line, that is, the 8th, the 14th, up to the 476th line of the sub display module 7, are transmitted sequentially from the data line 19, and the shift registers 20 shown in FIG. 17 operate in synchronization with the data transmissions, so that the digital image data is stored in the data registers 21. Once all digital image data is stored in the 80 pieces of data registers 21 in synchronization with the period TDA1, it is moved to the period TDA2, and at the same time, the digital image data is transferred to the latch circuits 22 at once. The digital image data stored in the latch circuits 22 is provided to the 6-bit DACs 24 through the level shifters 23 by every bit. Based on the digital image data supplied, the 6-bit DACs 24 output an analog voltage (display data) to be supplied to the sub display module 7.

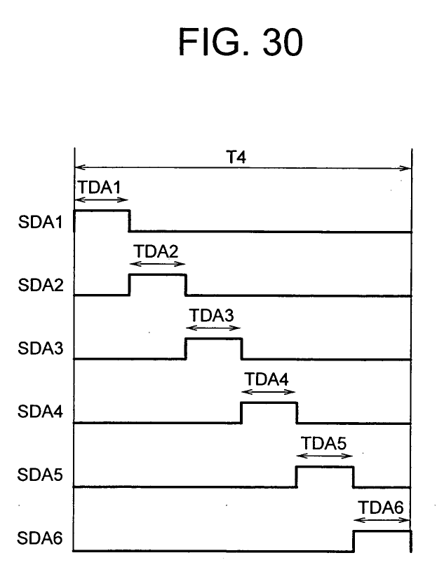

FIG. 29 is a chart showing an example of a circuit configuration of a group of switches 14a among eighty groups of switches 14a contained in the switching circuits 14 mounted on the sub display module 7, and FIG. 30 is a timing chart of switching signals SDA1 to SDA6 of a group of switches 14a.

An input terminal IN of the group of switches 14a connects with one output terminal of the DACs, respectively. Further, the output terminals of the group of switches 14a connect with a data bus line by every six terminals sequentially. Further, the output timings of the switching signals SDA1 to SDA6 are synchronized with the periods TDA1 to TDA6. In the period TDA1, a switching signal SDA1 is selected, and in the period TDA2, a switching signal SDA2 is selected. In the same manner, the period TDA3 corresponds to a switching signal SDA3, and the period TDA6 corresponds to a switching signal SDA6, respectively. For example, in the period TDA2, the signal SDA2 is selected, and respective DAC outputs are supplied to the data bus lines of every six lines from the 2nd line, that is, the 8th, the 14th, up to the 476th lines, through the switches, which are turned on, in the group of switches 14a. Here, analog signals (display data) are supplied to pixels at crossing parts between the 1st gate bus line and every six data bus lines from the 2nd line, that is, the 8th, the 14th, up to the 476th lines of the sub display module 7.

In this way, during the periods TDA3 to TDA6, digital image data to be supplied to the data bus lines are stored sequentially, and are converted from digital to analog, and are outputted. When the image data of analog signals are inputted in the switching circuit 14, the analog signals are switched by switches sequentially and are supplied to the data bus lines. As for the 1st, the 7th, the 13th, up to the 475th data of the sub display unit to be outputted in the period TDA1, the digital image data to be supplied to the data bus lines is stored at the same timing as the period TDA1 in a period just before the period TD1, and the data is converted from digital to analog, and outputted to the data bus lines. Further, in the period TDA6, signals to be supplied to the pixels at the crossing parts between the 2nd gate bus line and every data bus lines from the 1st line, that is, the 7th, the 13th, up to the 475th lines of the sub display module 7, are transmitted from the data line 19 sequentially.

In other words, by sequentially outputting the switching signals SDA1 to SDA6, image data of one gate bus line can be outputted to the data bus lines. By sequentially performing this operation for each gate bus line, images for one screen can also be displayed on the display device 9 of the sub display module 7.

Note that the present invention can also enjoy the effect of the first embodiment described above. Further, the modifications of the embodiment shown in the description of the first embodiment can be adopted as modifications of the present invention.

In the present invention described above, in order to mount the circuit module on the insulating substrate on which the sub display unit (sub display module) is mounted, the sub display module is set to be smaller in size than the main display unit (main display module). Although, in the aforementioned embodiment, such an example has been described that the size of the sub display unit is set to be smaller than that of the main display unit by differing the number of pixels or the sizes of the display areas, the present invention is not limited to this aspect. The size of the sub display unit may be set to be smaller than that of the main display unit by differing the number of pixels and the sizes of the display areas. In such a case, it is desirable that the size of the sub display be set to be smaller than that of the main display unit by reducing the number of pixels and by increasing the display area.

In a case where the aforementioned display system according to the present invention is incorporated in the portable telephone shown in FIGS. 6A and 6B, the display device 8 formed on the insulating substrate (6a), the display device 9 formed on the insulating substrate (7a), and the circuit module (13) which outputs display driving signals are built into the manipulation unit 2 and the monitor 3. Further, the size of the display device 9 is set to be smaller than the size of the display device 8, and one display unit, that is, the display device 8, is provided to the front face of the monitor 3, and the other display unit, that is, the display device 9 is provided to the back face of the monitor 3. In this case, the circuit module (13) is formed on the insulating substrate (7a) so as to be built into the monitor 3. Then, the display driving signals outputted from the circuit module are inputted into the one display unit and the other display unit, respectively. It should be noted that although the display system of the present invention is built into a portable telephone which is one of electronic equipment, the present invention is not limited to this.

1. A display system comprising:
one display unit formed on one insulating substrate;
another display unit formed on another insulating substrate; and
a circuit module for outputting display driving signals for causing the display units to perform displays, wherein
a size of the other display unit is set to be smaller than a size of the one display unit, and
the circuit module is formed on the other insulating substrate and outputs the display driving signals to the one display unit and to the other display unit, respectively.

2. The display system, as claimed in claim 1, wherein the display units include, on the insulating substrates, thin film field effect transistors and display devices driven by the thin film field effect transistors, and
the circuit module comprises a thin film field effect transistor, and outputs the display driving signals for driving the display devices by driving the thin film field effect transistor.

3. The display system, as claimed in claim 1, wherein the display units are active matrix type display units.

4. The display system, as claimed in claim 1, wherein the circuit module divides one frame period into continuous one screen rewrite period and another screen rewrite period, and outputs the display driving signal to the one display unit in the one screen rewrite period and outputs the display driving signal to the other display unit in the other screen rewrite period.

5. The display system, as claimed in claim 1, wherein the one display unit and the other display unit have different number of pixels.

6. The display system, as claimed in claim 1, wherein the one display unit and the other display unit have different display area sizes.

7. The display system as claimed in claim 1, wherein the one display unit and the other display unit have different number of pixels and different display area sizes.

8. The display system, as claimed in claim 1, wherein the circuit module includes at least such elements as:
a power supply circuit for generating power supply voltages supplied to the one display unit and to the other display unit;
a logic controller for generating digital signals supplied to the one display unit and to the other display unit; and
a digital to analog converter circuit which outputs display data to be supplied to the display units.

9. The display system, as claimed in claim 8, wherein the circuit module includes an integrated circuit chip, and a part of the elements included in the circuit module is formed on the integrated circuit chip, separated from the circuit module.

10. The display system, as claimed in claim 9, wherein the integrated circuit chip includes a memory circuit for storing image data supplied from an outside.

11. The display system, as claimed in claim 9, wherein the integrated circuit chip is driven by a single power source.

12. The display system, as claimed in claim 1, wherein the circuit module supplies all voltages required for driving the one display unit and the other display unit.

13. The display system, as claimed in claim 12, wherein the circuit module supplies at least one voltage to be supplied to the other display unit via wiring passing through the one display unit.

14. A display system, wherein
one display unit according to claim 1 formed on one insulating substrate, another display unit according to claim 1 formed on another insulating substrate, and a circuit module according to claim 1 for outputting display driving signals, are incorporated in a casing of electronic equipment,
a size of the other display unit is set to be smaller than a size of the one display unit,
the circuit module is formed on the other insulating substrate and is incorporated in the casing of the electronic equipment, and
the display driving signals outputted from the circuit module are inputted into the one display unit and to the other display unit, respectively.
